(19) United States
(12) Patent Application Publication
(10) Pub. No.: US 2007/0240886 A1
(43) Pub. Date: Oct. 18, 2007

(54) Thermosensitive Sprinkler

(76) Inventors: Jong-Jin Kil, Bucheon-si (KR); Hyun-Soo Kil, Bucheon-si (KR)

Correspondence Address: IPLA P.A., 3580 WILSHIRE BLVD., 17TH FLOOR, LOS ANGELES, CA, 90010, US

(21) Appl. No.: 11/572,202

(22) PCT Filed: Jul. 19, 2005
(86) PCT No.: PCT/KR05/02319

§ 371 Date: Jan. 16, 2007

(30) Foreign Application Priority Data
Jul. 28, 2004 (KR) 10-2004-0059444
Jul. 4, 2005 (KR) 10-2005-0059693

(51) Int. Cl. A62C 37/14

(52) U.S. Cl. 169/39

(57) ABSTRACT

Disclosed herein are a fire fighting sprinkler which has a sensor therein to detect a temperature, checks the presence of faults therein by itself, and is automatically actuated locally when fires occur, thus controlling sprinklers installed at several places in a centralized manner, therefore more effectively coping with the occurrence of fires, and a method of controlling the fire sprinkler In the thermo-sensitive sprinkler having a thermal fuse, the thermal fuse includes a casing having an open space therein, a low-temperature fusing material accommodated in the open space, an actuating pin seated in the low-temperature fusing material to be supported by the low-temperature fusing material, thus supporting a discharge valve, an electric heater to heat the low-temperature fusing material, and a power line to supply electricity to the electric heater, the power line comprising a thermocouple having a temperature measuring part where first and second conductors meet.

### TECHNICAL FIELD

The present invention relates, in general, to sprinklers and, more particularly, to a fire fighting sprinkler which has a sensor therein to detect a temperature, checks the presence of faults therein by itself, and is automatically actuated locally when fires occur, thus controlling sprinklers installed at several places in a centralized manner, therefore more effectively coping with the occurrence of fires, and to a method of controlling the fire sprinkler.

### BACKGROUND ART

Generally, a sprinkler is fire fighting equipment which is installed on a ceiling of a building and sprays extinguishing liquid, for example, water, upon sensing the occurrence of fires, thus putting out the fires. As shown in FIG. 1, a conventional sprinkler head H includes an extinguishing liquid discharging nozzle 1, an O-ring-shaped body 2, an extinguishing liquid diffusing plate 6, a discharge valve 3, a trigger 4, and a thermal fuse F. The discharging nozzle 1 is coupled to a liquid supply pipe via a pipe coupling socket. The body 2 extends downwards from the outer surface of the discharging nozzle 1. The liquid diffusing plate 6 is horizontally mounted to a lower end of the O-ring-shaped body 2. The discharge valve 3 closes the discharging nozzle 1. The trigger 4 is provided in a space between the discharge valve 3 and the lower portion of the body 2, and supports the discharge valve 3. The thermal fuse F is installed in the trigger 4.

As shown in FIG. 2, the thermal fuse F includes a casing 11, a low-temperature fusing material 13, and an actuating pin 12. The casing 11 has the shape of a drum which is closed at the bottom thereof and is hollow therein. The low-temperature fusing material 13 is loaded into the casing 11, and has a solid phase at room temperature. The lower portion of the actuating pin 12 is held by the low-temperature fusing material 13, and the upper portion of the actuating pin 12 protrudes out of the top of the casing 11. When the ambient temperature rises due to the occurrence of a fire, the low-temperature fusing material 13 (e.g. lead) of the thermal fuse F is fused, thus being converted into a liquid phase, and the actuating pin 12 is sunk in the molten lead, thus upsetting the valve-supporting balance of the trigger 4. Therefore, the discharge valve 3 opens the discharging nozzle 1 to spray extinguishing liquid.

Another conventional sprinkler has been proposed, which uses a glass ampoule filled with a temperature-expansive gas, in place of the above low-temperature fusing lead-type thermal fuse. When a fire occurs, the gas contained in the glass ampoule expands, so that the glass ampoule is broken. Thereby, the ability to support a discharge valve is lost. The operational principle of the sprinkler is similar to that of the sprinkler using the low-temperature fusing lead-type thermal fuse.

The conventional sprinkler using the low-temperature fusing lead-type fuse or the thermal expansive glass ampoule is problematic in that the fuse or glass ampoule reacts directly to the heat of a fire, so that the sprinkler is not actuated until the ambient temperature reaches the fusing point of the low-temperature lead or the temperature at which the glass ampoule expands and breaks, even though a fire occurs, thereby the sprinkler has a very slow response to the initial stage of the fire.

At present, fire fighting equipment, such as sprinklers, is installed in almost all buildings. However, since the fire fighting equipment is provided only against emergencies, such as the occurrence of a fire, the fire fighting equipment may be left unused for a lengthy period of time in the absence of a fire. Thus, as time passes, the fire fighting equipment may age and part of the electric circuits of the equipment may be damaged. Thereby, the fire fighting equipment may be useless when a fire actually breaks out. In order to solve the problem, the operation of the sprinklers must be frequently tested. However, it is not easy to frequently test a large number of sprinklers installed on the ceiling.

In most cases, a fire begins at a certain local place. Thus, only the sprinkler installed at the place is actuated, and other indoor sprinklers adjacent thereto are not actuated. Therefore, it is impossible to prevent the fire from spreading towards adjacent rooms.

In consideration of the foregoing problems in the conventional sprinklers, sprinklers shown in FIGS. 2 to 6 were proposed by the present inventor. FIG. 3 is a sectional view of an improved sprinkler disclosed in Korean Laid-Open Publication No. 2001-0082794, FIG. 4 is a sectional view of a thermal fuse used in the sprinkler of FIG. 3, FIG. 5 is a sectional view of an improved sprinkler disclosed in Korean Laid-Open Publication No. 2001-0102616, and FIG. 6 is a sectional view of an ampoule used in the sprinkler of FIG. 5.

Referring to FIGS. 3 and 4, the thermal fuse F includes a drum-shaped non-conductive casing 11. An electric contact part 10 is attached to or formed on the bottom of the casing 11, and is electrically connected to a cathode conductor 9 connected to a negative (−) pole. An anode conductor 8 connected to a positive (+) pole is attached to the inner surface of the casing 11. Further, a coiled electric heater 14 is mounted to the outer surface of the casing 11. One terminal of the electric heater 14 is connected to the electric contact part 10, while the other terminal of the electric heater 14 is connected to the anode conductor 8 via a low-temperature fusing material 13. The outer surface of the electric heater 14, that is, the outermost part of the casing 11, is coated with a corrosion-resistant and insulating coating film 15, thus protecting the electric heater 14. Preferably, the electric heater 14 is made of a material such as carbon paste or metal film.

Referring to FIGS. 5 and 6, an ampoule 200 has a structure where an electric heating coil 120 is inserted into a conventional hollow and cylindrical glass ampoule charged with thermal expansive gas or liquid G. The ampoule 200 includes a hollow and cylindrical housing 100, the electric heating coil 120, a first electrode part 140, a second electrode part 142, and a thermal expansive fluid G. The housing 100 is made of glass, and is sealed at an interior thereof. The electric heating coil 120 is longitudinally inserted into the housing 100 along a central axis thereof. The first electrode part 140 is mounted to the outer surface of the lower end of the housing 100, and is connected to a lower end 122 of the electric heating coil 120. The second electrode part 142 passes through a sidewall 102 of the housing, and extends into the housing 100 to be connected to an upper end 124 of the electric heating coil 120. The thermal expansive fluid G is charged in the housing 100.

Each of the sprinklers constructed as shown in FIGS. 3 to 6 is coupled to a temperature sensor (not shown), a sprinkler head controller (not shown), and a main computer (not shown) of a main command station. The temperature sensor TS is used to detect the occurrence of a fire, and is installed on the sprinkler head which is easy to detect high heat caused by the fire occurring in a building.

The sprinkler head controller has a current supply/feedback unit (not shown) that supplies a predetermined rating of current to the thermal fuse F or the ampoule A and detects the amount of current flowing through the thermal fuse F or the ampoule A, thus applying a predetermined rating of current to the thermal fuse F or the ampoule A, and analyzing the current detected by the current supply/feedback unit. Based on the analyzed result, the sprinkler head controller determines whether the thermal fuse F or the ampoule A is out of order or has aged. To this end, a one chip microcontroller (hereinafter, referred to as a “micom”) is required.

When the presence of a fire is detected by the temperature sensor, current is applied to the thermal fuse F or the ampoule A by the controller, so the electric heater 14 or the electric heating coil 120 generates heat. Thereby, the low-temperature fusing material 13 is fused or the thermal expansive fluid G is expanded, so the actuating pin 12 moves downwards or the housing 100 is broken, thus opening the discharge valve 3.

The improved sprinklers constructed as described above are advantageous in that they are rapidly actuated, their states can be checked, and sprinklers provided at desired positions can be independently actuated. However, the sprinklers are disadvantageous in that temperature sensors must be additionally installed at predetermined positions of the sprinklers so as to actuate the sprinklers, so that it is complicated to install. Particularly, in the case whether the sprinklers are installed throughout a larger area, the temperature sensors must be installed at several places, so that they are complicated to install, and high installation costs are incurred.

### DISCLOSURE OF INVENTION

### TECHNICAL PROBLEM

Accordingly, the present invention has been made keeping in mind the above problems occurring in the prior art, and an object of the present invention is to provide a sprinkler, which has a sensor therein to detect a temperature, so that it is not necessary to install an additional temperature sensor.

Another object of this invention is to provide a sprinkler, which is capable of detecting temperature through a simple construction, transmitting the detected temperature to a control unit, and is individually actuated under the control of the control unit.

A further object of this invention is to provide a sprinkler, capable of self-diagnosing the state thereof.

### TECHNICAL SOLUTION

In order to accomplish the objects, the present invention provides a thermo-sensitive sprinkler having a thermal fuse, the thermal fuse including a casing having an open space therein; a low-temperature fusing material accommodated in the open space; an actuating pin seated in the low-temperature fusing material to be supported by the low-temperature fusing material, thus supporting a discharge valve; an electric heater to heat the low-temperature fusing material; and a power line to supply electricity to the electric heater, the power line comprising a thermocouple having a temperature measuring part where first and second conductors meet.

A first end of the electric heater is connected to a first end of the power line, the first conductor is connected to a second end of the electric heater, and the second conductor is connected to a second end of the power line.

The actuating pin has on an upper end thereof a conductive connecting part which comprises a conductor, the conductive connecting part having on an upper portion thereof an insulating washer that contacts the discharge valve, the actuating pin and the low-temperature fusing material comprise a conductor, the conductive connecting part is connected to a first end of the power line, the electric heater contacts the low-temperature fusing material, a first end of the electric heater being connected to a second end of the power line, and the thermocouple is connected to the conductive connecting part or the first end of the electric heater.

An electric contact part is provided at a predetermined position on the thermal fuse, and is connected to a first end of the power line, the electric contact part being connected to a first end of the electric heater, a second end of the electric heater is connected to a second end of the power line, and the thermocouple is connected to the electric contact part or the second end of the electric heater.

In a thermo-sensitive sprinkler having an ampoule, the ampoule includes a housing having an empty space therein; an expansive fluid contained in the empty space; and an electric heating coil to heat the expansive fluid, the electric heating coil being coupled to a thermocouple having a temperature measuring part where first and second conductors meet.

A first end of the electric heating coil is connected to a first end of a power line, a second end of the electric heating coil is connected to the thermocouple, and the thermocouple is connected to a second end of the power line.

The electric heating coil and the first conductor are integrated into a single structure using one conductor, and the second conductor is attached to the first end of the electric heating coil.

In a thermo-sensitive sprinkler having an ampoule, the ampoule includes a housing having an empty space therein; an expansive fluid contained in the empty space; and an electric heating coil to heat the expansive fluid, the electric heating coil comprising a first electric heating coil made of a first conductor and a second electric heating coil made of a second conductor, the first and second electric heating coils being attached to each other, thus providing a temperature measuring part.

The temperature measuring part is positioned outside the housing.

The first electric heating coil is connected to a first electrode part provided at a pre-determined position an outer surface of the housing, and the second electric heating coil is connected to a second electrode part provided at a predetermined position on the outer surface of the housing.

The terms used herein, “connection and contact”, denote electrical connection and contact, without being limited to direct physical connection and contact.

### ADVANTAGEOUS EFFECTS

According to the present invention, a temperature detecting and heating structure is integrally provided in a sprinkler, so that it is not necessary to manufacture and install an additional temperature sensor, thus reducing manufacturing costs of the sprinkler and costs of a product.

Further, this invention provides a sprinkler, which detects a temperature, and is individually actuated in response to the detected temperature.

The present invention provides a sprinkler, which is capable of diagnosing the failure in the sprinkler by itself.

Further, even when there is a failure, such as the damage to an electric circuit or a defective contact, the sprinkler of this invention is actuated by itself, thus securing increased safety.

### BRIEF DESCRIPTION OF THE DRAWINGS

FIG. 1 is a sectional view of a general sprinkler which is used at present;

FIG. 2 is a sectional view of a thermal fuse used in the sprinkler of FIG. 1;

FIG. 3 is a sectional view of an improved sprinkler disclosed in Korean Laid-Open Publication No. 2001-0082794;

FIG. 4 is a sectional view of a thermal fuse used in the sprinkler of FIG. 3;

FIG. 5 is a sectional view of an improved sprinkler disclosed in Korean Laid-Open Publication No. 2001-0102616;

FIG. 6 is a sectional view of an ampoule used in the sprinkler of FIG. 5;

FIG. 7 is a sectional view of a thermal fuse used in a sprinkler, according to the present invention;

FIG. 8 is a plan view of the thermal fuse of FIG. 7;

FIG. 9 is a bottom view of the thermal fuse of FIG. 7;

FIG. 10 is a sectional view of a sprinkler using the thermal fuse of FIG. 7;

FIG. 11 is a sectional view of another thermal fuse used in the sprinkler, according to this invention;

FIG. 12 is a sectional view of an ampoule used in the sprinkler, according to this invention;

FIG. 13 is a plan view of the ampoule of FIG. 12;

FIG. 14 is a bottom view of the ampoule of FIG. 12;

FIG. 15 is a sectional view of a sprinkler using the ampoule of FIG. 12;

FIG. 16 is a sectional view of another ampoule used in the sprinkler of this invention;

FIG. 17 is a sectional view of a sprinkler using the ampoule of FIG. 16;

FIG. 18 is a sectional view of a further ampoule used in the sprinkler of this invention;

FIG. 19 is a sectional view of a sprinkler using the ampoule of FIG. 18;

FIG. 20 is a sectional view of a further ampoule used in the sprinkler of this invention;

FIG. 21 is a sectional view of a sprinkler using the ampoule of FIG. 20;

FIG. 22 is a sectional view of a further ampoule used in the sprinkler of this invention;

FIG. 23 is a sectional view of a sprinkler using the ampoule of FIG. 22;

FIG. 24 is a sectional view of a further ampoule used in the sprinkler of this invention;

FIG. 25 is a sectional view of a sprinkler using the ampoule of FIG. 24;

FIG. 26 is view illustrating a further ampoule used in the sprinkler of this invention in a sectional view and a bottom view;

FIG. 27 is a sectional view of a sprinkler using the ampoule of FIG. 26; and

FIG. 28 is a view to schematically show the state where the sprinkler of this invention is connected to a control unit (micom).

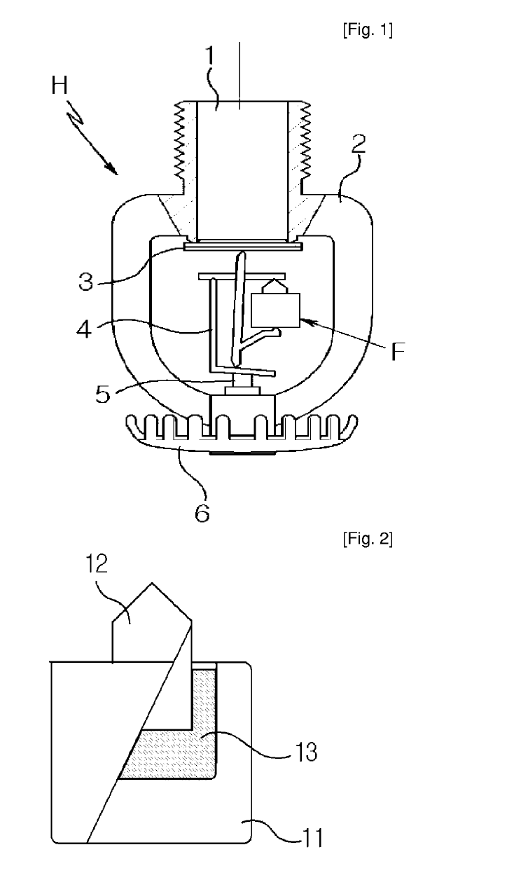

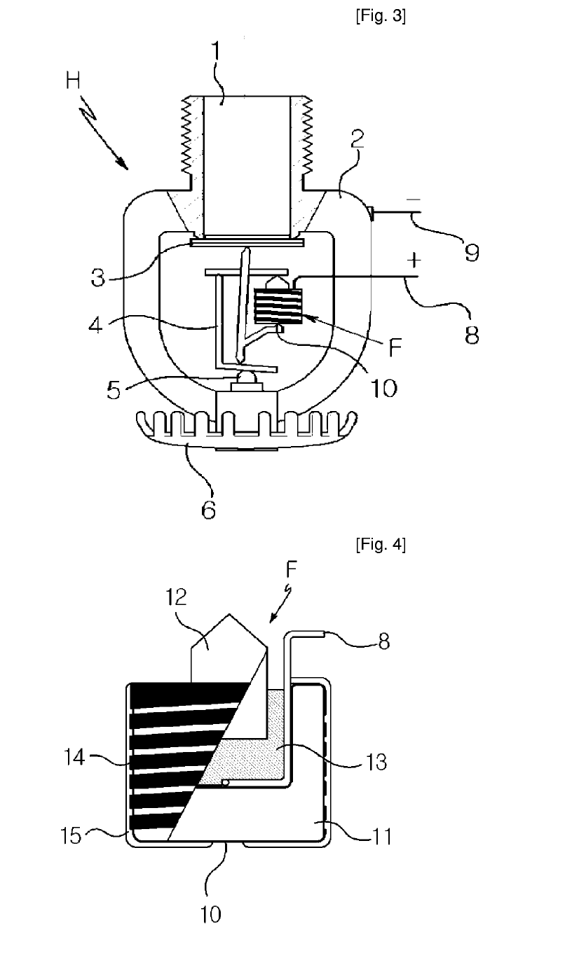

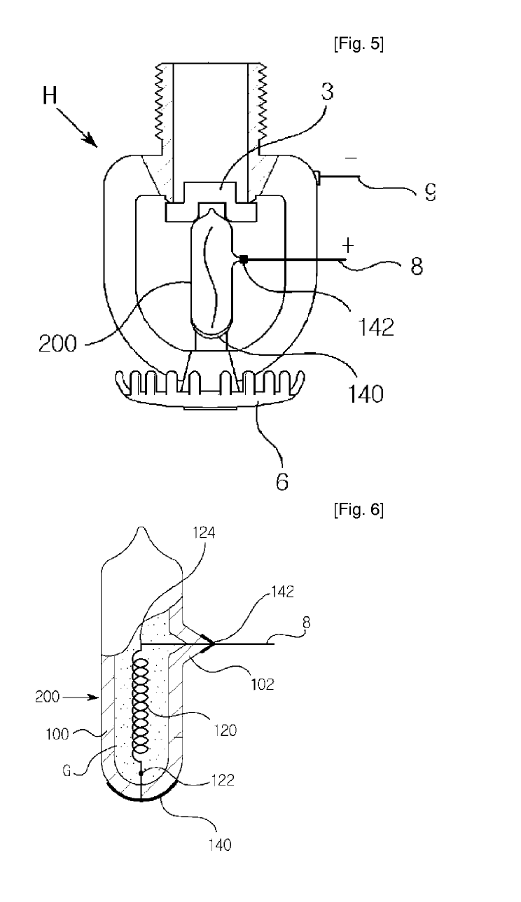

### BEST MODE FOR CARRYING OUT THE INVENTION

Hereinafter, the construction of this invention will be described in detail with reference to the accompanying drawings illustrating the preferred embodiments of this invention.

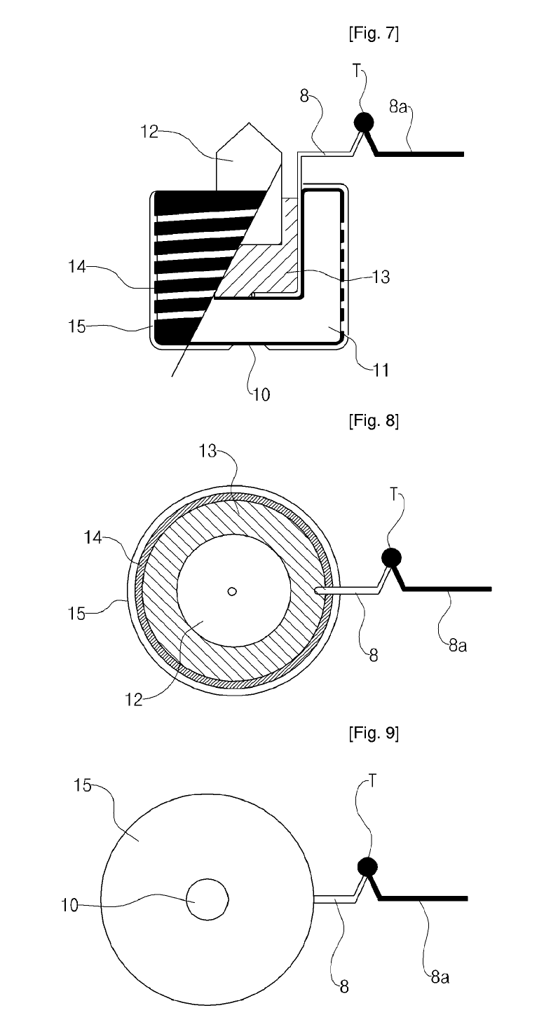

FIG. 7 is a sectional view of a thermal fuse used in a sprinkler, according to the present invention, FIG. 8 is a plan view of the thermal fuse of FIG. 7, and FIG. 9 is a bottom view of the thermal fuse of FIG. 7. Referring to FIGS. 7 to 9, unlike a conventional construction, this invention is provided with different first and second conductors 8 and 8a, which are joined together to provide a thermocouple. A junction of the first and second conductors 8 and 8a forms a temperature measuring part T. According to the principle of the thermocouple, temperature can be detected at the temperature measuring part T. The first conductor 8 is connected to an electric heater 14 in series, and the second conductor 8a is connected to a power source. According to a connecting position of the first conductor 8, an actuating pin 12 may be a conductor or a non-conductor.

The first and second conductors 8 and 8a use thermocouple metal lead wires which function as the thermocouple and supply electricity to the electric heater 14. The temperature measuring part T where the first and second conductors 8 and 8a meet is exposed to the atmosphere, thus minimizing the outflow or inflow of heat due to peripheral units of the thermal fuse F, thus having excellent temperature sensitivity. Particularly, when the weight of the temperature measuring part T of the thermocouple is minimized to be several milligrams (mg) or the less, the temperature measuring part T can respond immediately to the atmospheric air.

Preferably, a cover 15 is applied to the outer surface of a casing 11 using an insulating material, such as corrosion-resistant enamel, in such a way that the cover does not hinder heat conduction. One end of the electric heater 14 is connected to one terminal of the power source, while the other end of the electric heater 14 is connected to the first conductor 8 of the thermocouple comprising the first and second conductors 8 and 8a. Further, the second conductor 8a is connected to a bidirectional input and output control port of a control unit, that is, a micom.

A temperature detecting operation, inputting and outputting operations, a heating operation, and a self-diagnosing operation of the sprinkler will be described with reference to FIG. 28.

[Temperature Detecting and Inputting Operation]

In proportion to the temperature of the temperature measuring part T, electromotive force is generated between the first and second conductors 8 and 8a. When the electromotive force is applied to the control unit (not shown) which is the micom, the micom amplifies the electromotive force in a directly proportional manner, and analyzes the signal, thus determining whether the signal exceeds a proper temperature. If it is determined that the temperature exceeds the proper temperature and a fire occurs, the input port, connected to the first and second conductors 8 and 8a, is converted into the output port.

At this time, since the electromotive force generated at the temperature measuring part T is very low, an internal resistor of the electric heater 14 connected to the first and second conductors 8 and 8a in series is not heated. Thus, electric power consumed in the internal resistor of the electric heater 14 by the electromotive force of the temperature measuring part T may be neglected. In order to transmit the low electromotive force generated at the temperature measuring part T to the micom without loss, the input impedance of the micom must be several mega-ohms ( [symbol] ) or more. Thus, the low electromotive force generated at the temperature measuring part T passes through the internal resistor of the electric heater 14 having dozens of ohms (Ω), and is transmitted to the input terminal of the micom having an infinite resistance value of several mega-ohms ( [symbol] ) or more. Therefore, the internal resistance value of the electric heater 14 of dozens of ohms (Ω) is neglected, and the electromotive force is transmitted to the micom without loss. Such a process is an operation of detecting a temperature through the input port.

[Outputting and Heating Operation]

The heating operation through the output port is executed as follows. That is, when a signal output from the micom is applied to the internal resistor of the electric heater 14 through the thermocouple metal lead wires, the heating operation is carried out. At this time, the electromotive force generated in the thermocouple is several millivolts (mV) or less, and the internal resistance is very low, that is, 1 ohm (Ω) or less, so that they do not affect the heating voltage or current. Thus, the electric heater 14 is heated without loss due to the thermocouple.

The current, applied to the first and second conductors 8 and 8a through the converted output port, heats the electric heater 14, so that a low-temperature fusing material 13 is fused. Thereby, the actuating pin 12 sinks downwards, so that the discharge valve 3 is open, thus spraying extinguishing liquid.

[Self-Diagnosing Operation]

The electric heater 14 and the first and second conductors 8 and 8a constituting the thermocouple are connected in series. Thus, when there occurs physical damage, that is, one of the parts is disconnected or the connection is defective, the electromotive force is lost and changed at the temperature measuring part T of the thermocouple. The lost electromotive force signal is transmitted to the micom. Through such a process, it is possible to determine whether the electric heater 14 is reliably connected, and whether the electric connection is reliable, thus realizing the self-diagnosing operation.

[Automatic Responding Operation]

Even if the electric heater 14 is not actuated due to the malfunction or the power failure, the low-temperature fusing material 13 is fused as the ambient temperature rises, thus causing the extinguishing liquid to be discharged. This invention serves as an automatic responding safety device.

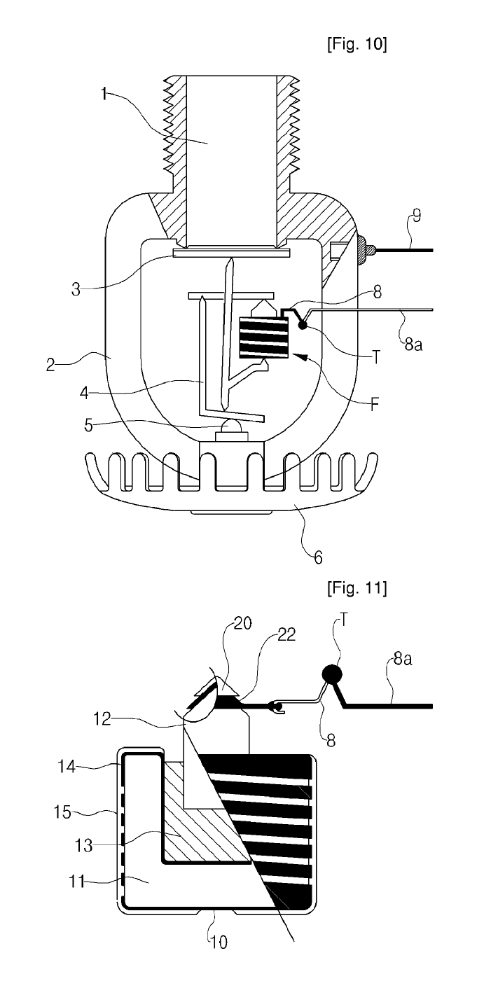

FIG. 10 is a sectional view of a sprinkler using the thermal fuse of FIG. 7. Referring to FIG. 10, a cathode conductor 9 and a second conductor 8a are connected to opposite ends of a power source. The cathode conductor 9 is connected to an electric contact part 10 of the thermal fuse F through a body 2, a support 5, and a trigger 4. The electric contact part 10 is connected to an electric heater 14. Further, the second conductor 8a is connected to a first conductor 8, and the first conductor 8 is connected to the electric heater 14 in series.

FIG. 11 is a sectional view of another thermal fuse used in the sprinkler of this invention. Referring to FIG. 11, a first conductor 8 is not connected to an electric heater 14 in series, but is connected to an actuating pin 12. In this case, the actuating pin 12 comprises a conductor. The first conductor 8 is connected to a conductive connecting part 22 covering the upper end of the actuating pin 12. The upper part of the conductive connecting part 22 is covered with an insulating washer 20 having an insulating function, such as ceramic. The insulating washer 20 prevents the first conductor 8 from being directly connected to the body 2, so that electricity does not flow between the first conductor 8 and the cathode conductor 9. The first conductor 8 is sequentially connected to the conductive connecting part 22, the actuating pin 12 made of a conductive material, the low-temperature fusing material 13, and the electric heater 14.

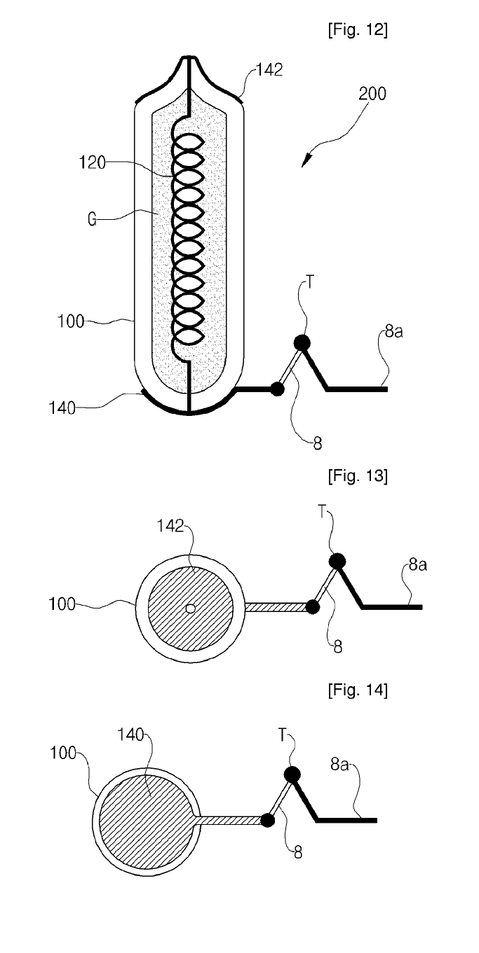

FIG. 12 is a sectional view of an ampoule used in the sprinkler of this invention, FIG. 13 is a plan view of the ampoule of FIG. 12, and FIG. 14 is a bottom view of the ampoule of FIG. 12. Referring to FIGS. 12 and 13, a second electrode part 142 is provided on the upper end of a glass housing 100 of the ampoule A, and a first electrode part 140 is provided on the lower end of the housing 100. A thermal expansive fluid G, which sensitively responds to heat and expands, is contained in the housing 100. A first conductor 8 and a second conductor 8a are connected to the first electrode part 140 in series, with a temperature measuring part T provided at a junction of the first and second conductors 8 and 8a.

In a similar manner to the foregoing description, temperature is measured at the temperature measuring part T provided at the junction of the first and second conductors 8 and 8a. Under the control of the micom that serves as the control unit, an electric heating coil 120 is heated. As the electric heating coil 120 generates heat, the thermal expansive fluid G expands, so the housing 100 is broken. Thereby, the discharge valve 3 supporting the housing 100 is opened, so that extinguishing liquid is discharged. In the same manner as the case using the thermal fuse F, the temperature detecting operation, the inputting operation, the outputting operation, the heating operation, the self-diagnosing operation, and the automatic responding operation are carried out in the sprinkler using the ampoule A.

FIG. 15 is a sectional view of a sprinkler using the ampoule of FIG. 12. Referring to FIG. 15, a cathode conductor 9 and the second conductor 8a are connected to both ends of a power source. The cathode conductor 9 is connected to the electric heating coil 120 of the ampoule A along a body 2, a discharge valve 3, and a second electrode part 142. The second conductor 8a is connected to the first conductor 8, and the first conductor 8 is connected to the electric heating coil 120 in series. In this case, the support 5 is insulated from the body 2, thus preventing electricity from flowing between the support 5 and the body 2.

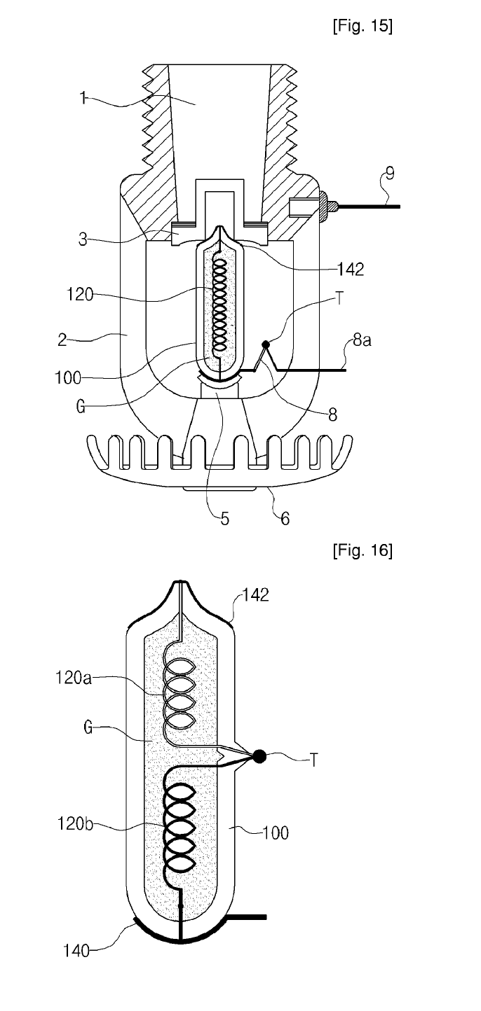

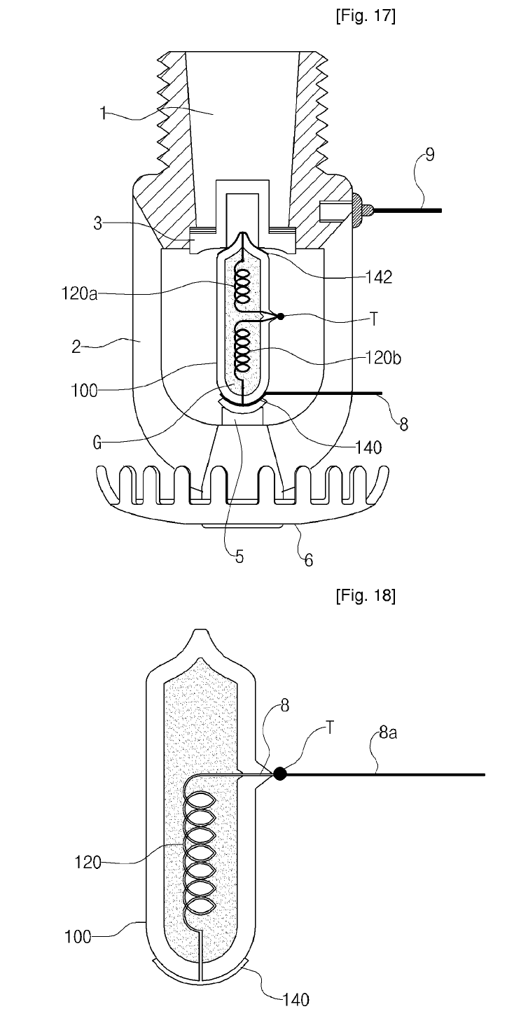

FIG. 16 is a sectional view of another ampoule used in the sprinkler of this invention, and FIG. 17 is a sectional view of a sprinkler using the ampoule of FIG. 16. Referring to FIGS. 16 and 17, the electric heating coil comprises first and second electric heating coils 120b and 120a which are made of different metals. A central part where the first and second electric heating coils 120b and 120a meet is exposed outside the housing 100, thus forming a temperature measuring part T. In this case, a support 5 is insulated from a body 2, so that electricity does not flow between the support 5 and the body 2. As necessary, after the body 2 is connected to both poles of a power source and electricity paths are separated from each other, it is possible to connect respective power sources to first and second electrode parts 140 and 142. In this case, the support 5 contacting the first electrode part 140 and a discharge valve 3 contacting the second electrode part 142 comprise conductors for allowing electric flow. A path connecting the discharge valve 3 through the body 2 to one end of the power source is separated from a path connecting the support 5 through the body 2 to the other end of the power source.

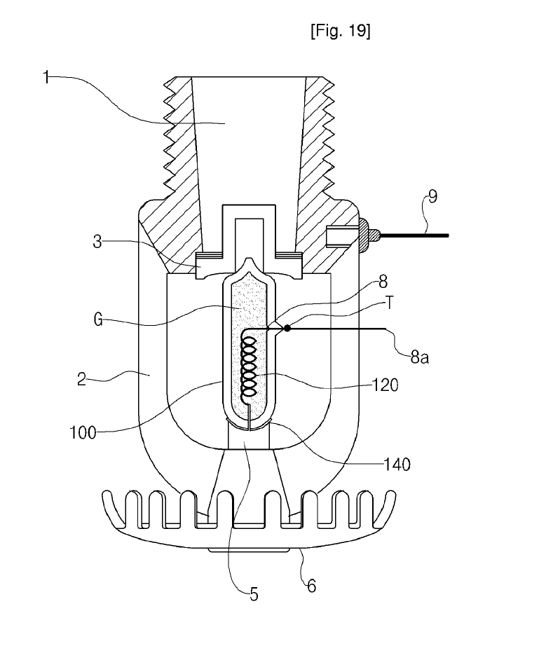

FIG. 18 is a sectional view of a further ampoule used in the sprinkler of this invention, and FIG. 19 is a sectional view of a sprinkler using the ampoule of FIG. 18. Referring to FIGS. 18 and 19, a first metal 8 extends inwards to form an inner electric heating coil 120. A first electrode part 140 is connected to the lower end of a housing 100. The first electrode part 140 is connected through a support 5 and a body 2 to a cathode conductor 9. In this case, the support 5 must be made of a conductor allowing the flow of electricity.

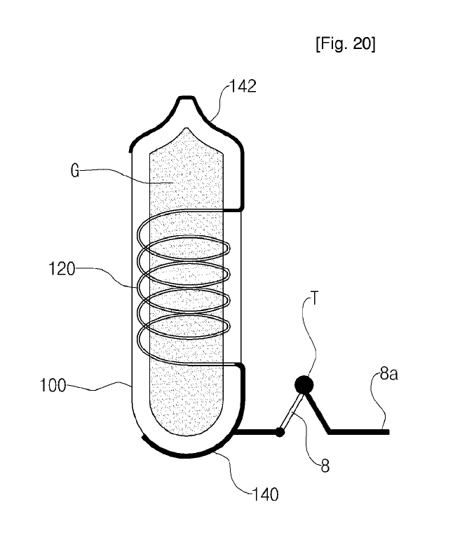

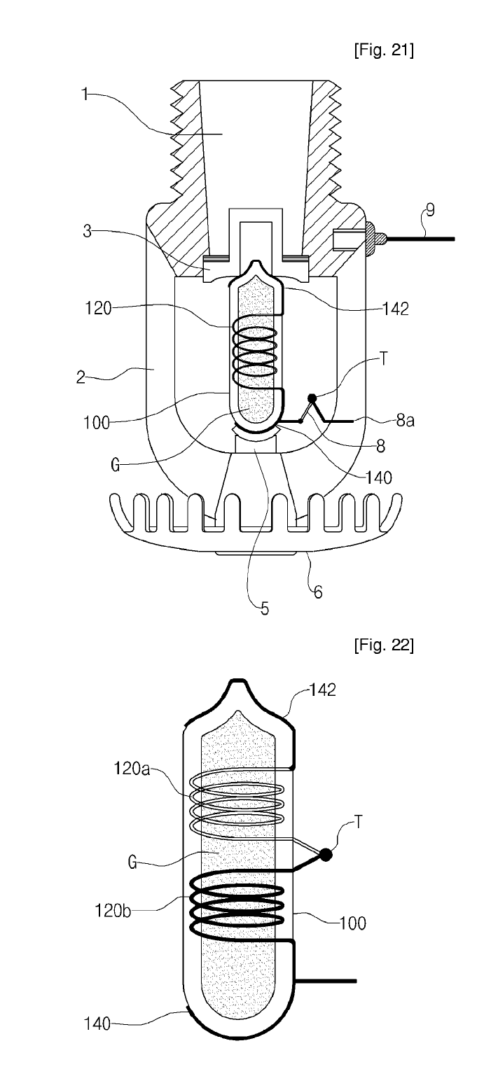

FIG. 20 is a sectional view of a further ampoule used in the sprinkler of this invention, and FIG. 21 is a sectional view of a sprinkler using the ampoule of FIG. 20. The general construction of FIGS. 20 and 21 is similar to that of FIGS. 12 through 15, except that an electric heating coil 120 indirectly heats a thermal expansive fluid G. To this end, the electric heating coil 120 is embedded in or wound around the outer surface of a housing 100 such that the electric heating coil 120 does not directly contact the thermal expansive fluid G.

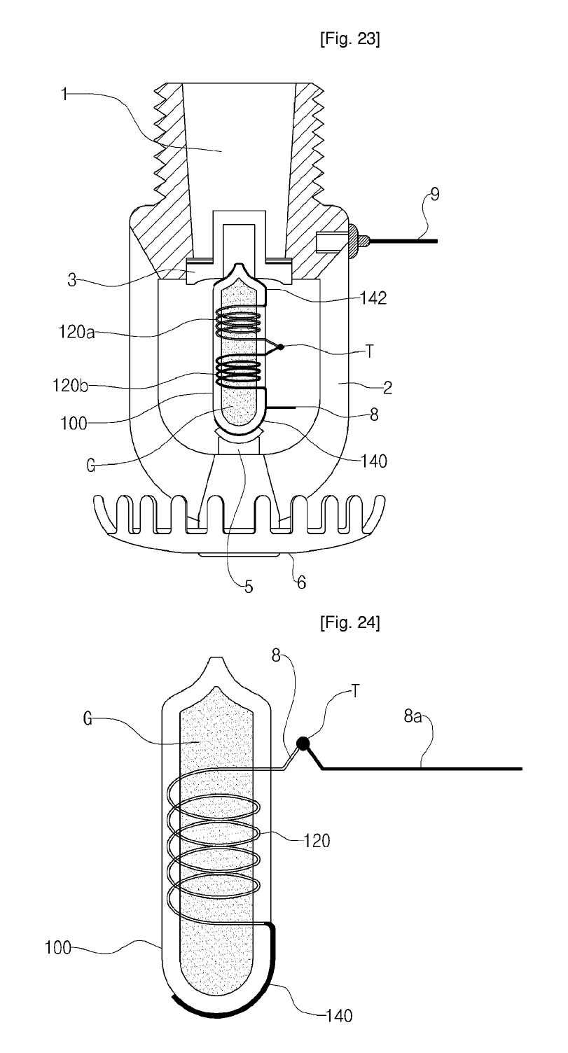

FIG. 22 is a sectional view of a further ampoule used in the sprinkler of this invention, and FIG. 23 is a sectional view of a sprinkler using the ampoule of FIG. 22. The general construction of FIGS. 22 and 23 is similar to that of FIGS. 16 and 17, except that an electric heating coil 120 indirectly heats a thermal expansive fluid G. To this end, the electric heating coil 120 is embedded in or wound around the outer surface of a housing 100 such that the electric heating coil 120 does not directly contact the thermal expansive fluid G.

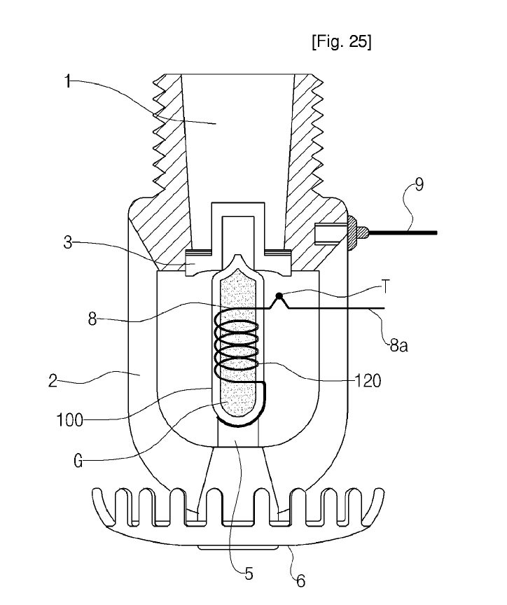

FIG. 24 is a sectional view of a further ampoule used in the sprinkler of this invention, and FIG. 25 is a sectional view of a sprinkler using the ampoule of FIG. 24. The general construction of FIGS. 24 and 25 is similar to that of FIGS. 18 and 19, except that an electric heating coil 120 indirectly heats a thermal expansive fluid G. To this end, the electric heating coil 120 is embedded in or wound around the outer surface of a housing 100 such that the electric heating coil 120 does not directly contact the thermal expansive fluid G.

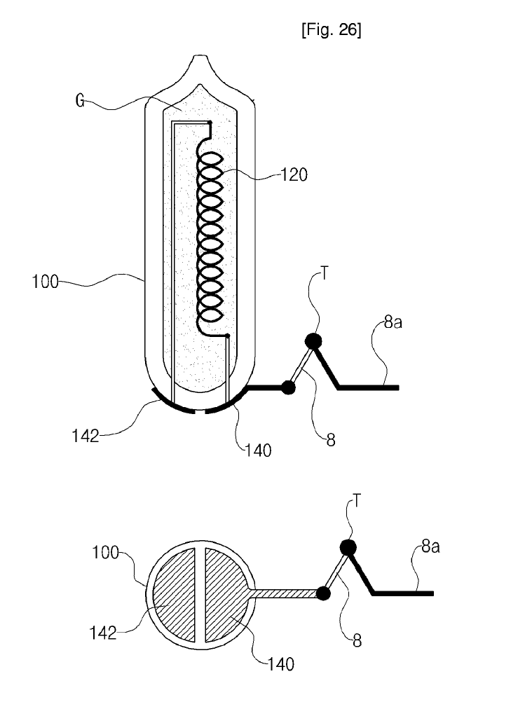

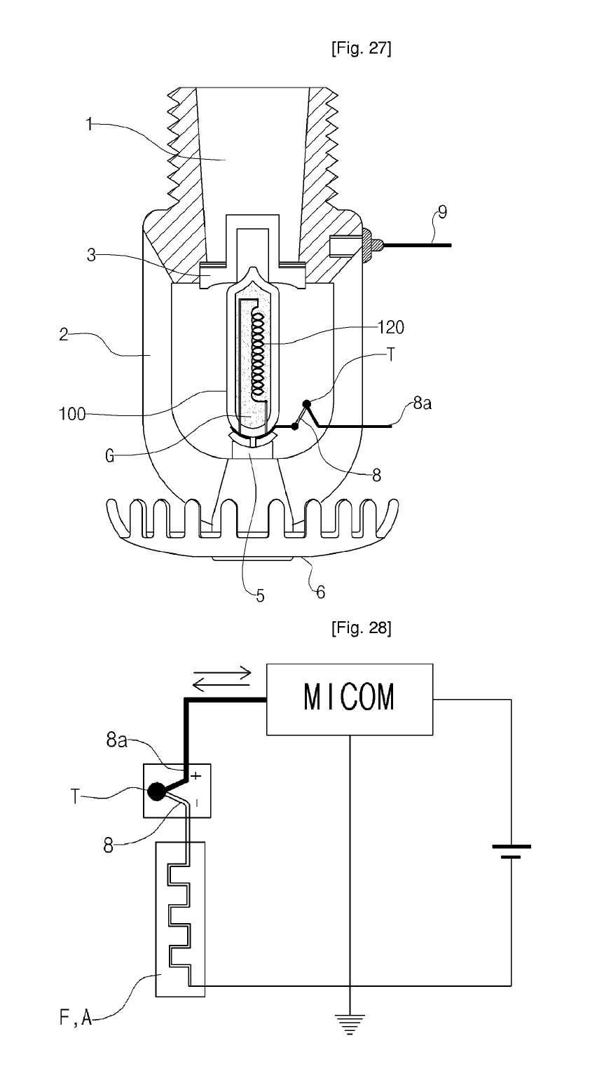

FIG. 26 is a view illustrating a further ampoule used in the sprinkler of this invention in a sectional view and a bottom view, and FIG. 27 is a sectional view of a sprinkler using the ampoule of FIG. 26. Referring to FIGS. 26 and 27, both a first electrode part 140 and a second electrode part 142 are provided on the lower end of the ampoule, and a support 5 is configured to be electrically connected only to the second electrode part 142. As shown in the drawings, an electric heating coil 120 may be in contact with a thermal expansive fluid G to directly heat the fluid G. Alternatively, the electric heating coil 120 may be embedded in or wound around the outer surface of a housing 100 so that the electric heating coil 120 indirectly heats the thermal expansive fluid G.

In order to supply current to the electric heater or the electric heating coil, the power source may be connected to the electric heater or the electric heating coil in various manners. The electric heater or the electric heating coil may be directly connected to the power source using a lead wire. The body of the sprinkler connected to a lead wire may be connected to the electrode part of the electric heater or the electric heating coil. Various modifications, additions and substitutions for the connecting methods are possible, without departing from the scope and spirit of the invention as disclosed in the accompanying claims.

1. A thermo-sensitive sprinkler having a thermal fuse, the thermal fuse comprising:
a casing having an open space therein;
a low-temperature fusing material accommodated in the open space;
an actuating pin seated in the low-temperature fusing material to be supported by the low-temperature fusing material, thus supporting a discharge valve;
an electric heater to heat the low-temperature fusing material; and
a power line to supply electricity to the electric heater, the power line comprising a thermocouple having a temperature measuring part where first and second conductors meet.

2. The thermo-sensitive sprinkler according to claim 1, wherein
a first end of the electric heater is connected to a first end of the power line,
the first conductor is connected to a second end of the electric heater, and
the second conductor is connected to a second end of the power line.

3. The thermo-sensitive sprinkler according to claim 1, wherein
the actuating pin has on an upper end thereof a conductive connecting part which comprises a conductor, the conductive connecting part having on an upper portion thereof an insulating washer that contacts the discharge valve,
the actuating pin and the low-temperature fusing material comprise a conductor,
the conductive connecting part is connected to a first end of the power line,
the electric heater contacts the low-temperature fusing material, a first end of the electric heater being connected to a second end of the power line, and
the thermocouple is connected to the conductive connecting part or the first end of the electric heater.

4. The thermo-sensitive sprinkler according to claim 1, wherein
an electric contact part is provided at a predetermined position on the thermal fuse, and is connected to a first end of the power line, the electric contact part being connected to a first end of the electric heater,
a second end of the electric heater is connected to a second end of the power line, and
the thermocouple is connected to the electric contact part or the second end of the electric heater.

5. A thermo-sensitive sprinkler having an ampoule, the ampoule comprising:
a housing having an empty space therein;
an expansive fluid contained in the empty space; and
an electric heating coil to heat the expansive fluid, the electric heating coil being coupled to a thermocouple having a temperature measuring part where first and second conductors meet.

6. The thermo-sensitive sprinkler according to claim 5, wherein
a first end of the electric heating coil is connected to a first end of a power line,
a second end of the electric heating coil is connected to the thermocouple, and
the thermocouple is connected to a second end of the power line.

7. The thermo-sensitive sprinkler according to claim 5, wherein
the electric heating coil and the first conductor are integrated into a single structure using one conductor, and
the second conductor is attached to the first end of the electric heating coil.

8. A thermo-sensitive sprinkler having an ampoule, the ampoule comprising:
a housing having an empty space therein;
an expansive fluid contained in the empty space; and
an electric heating coil to heat the expansive fluid, the electric heating coil comprising a first electric heating coil made of a first conductor and a second electric heating coil made of a second conductor,
the first and second electric heating coils being attached to each other, thus providing a temperature measuring part.

9. The thermo-sensitive sprinkler according to claim 8, wherein the temperature measuring part is positioned outside the housing.

10. The thermo-sensitive sprinkler according to claim 8, wherein
the first electric heating coil is connected to a first electrode part provided at a predetermined position an outer surface of the housing, and
the second electric heating coil is connected to a second electrode part provided at a predetermined position on the outer surface of the housing.
